(19) United States
(12) Patent Application Publication
(10) Pub. No.: US 2010/0064150 A1
(43) Pub. Date: Mar. 11, 2010

(54) POWER SUPPLY SYSTEM AND POWER SUPPLY METHOD

(76) Inventor: OSAMU HIGUCHI, Tokyo (JP)

Correspondence Address: Mr. Jackson Chen, 6535 N. STATE HWY 161, IRVING, TX, 75039, US

(21) Appl. No.: 12/552,357

(22) Filed: Sep. 2, 2009

(30) Foreign Application Priority Data
Sep. 8, 2008 (JP) P2008-230137

(51) Int. Cl. G06F 1/26

(52) U.S. Cl. 713/300

(57) ABSTRACT

A power supply system is adapted to a platform including a plurality of processing devices including baseboard management controllers (BMC) for processing basic information units, each of which is equipped with a plurality of power supply units (PSU) and at least one secondary power supply unit interconnected to a power cable. The controller calculates the maximum power consumption of the processing device based on its configuration, an adequate number of power supply units being turned on to meet the maximum power consumption, and a redundant power supply corresponding to one power supply unit times the adequate number minus the maximum power consumption. When the processing device suffers from a power shortage, the secondary power supply unit or the power supply unit of the other processing device is selectively turned on so as to recover the redundant power supply, thus normally achieving the N+1 redundancy of power supply.

### BACKGROUND OF THE INVENTION

The present application claims priority on Japanese Patent Application No. 2008-230137, the content of which is incorporated herein by reference.

### FIELD OF THE INVENTION

The present invention relates to power supply systems and power supply methods controlling redundant power supply on intensive information processing devices including computing machines such as platforms by way of baseboard management controllers (BMC).

### DESCRIPTION OF THE RELATED ART

Recently, various technologies for managing redundant power supply in electronic devices and computers have been developed and disclosed in various documents as follows:
Patent Document 1: Japanese Unexamined Patent Application Publication No. 2000-152496
Patent Document 2: Japanese Unexamined Patent Application Publication No. 2003-241859
Patent Document 3: Japanese Unexamined Patent Application Publication No. 2005-202506
Patent Document 4: Japanese Unexamined Patent Application Publication No. 2005-203381
Patent Document 5: Japanese Unexamined Patent Application Publication No. H02-311127

FIG. 6 shows a typical example of a power supply system for managing redundant power supply on a plurality of processing devices for processing basic information units (namely, four cell boxes 10 to 13), wherein for the purpose of redundant power supply, each cell box is equipped with a plurality of power supply units (PSU) being turned on so as to prepare for failures occurring on other power supply units.

The power supply system of FIG. 6 is adapted to a single information processing platform including the four cell boxes 10-13 and is designed such that the maximum power consumption of each cell box falls within the sum of powers of two power supply units, thus achieving an N+1 redundancy of power supply and securing an uninterrupted power supply to each cell box regardless of a failure occurring on one power supply unit.

In FIG. 6, the platform including the four cell boxes 10-13 needs the total of twelve power supply units because each cell box is equipped with three power supply units being normally turned on. The platform including the four cell boxes 10-13 needs an independent power control by itself in order to achieve low power consumption and power saving.

It is necessary for practical models of the power supply system to meet power saving requirements and to thereby demonstrate a redundancy in power distribution.

In addition, it is necessary for them to maintain an adequate reliability and a redundancy in power distribution with a low cost.

Various devices and methods have been developed with regard to power distribution among plural devices so as to secure the same reliability as the foregoing platform demonstrating an N+1 redundancy for the uninterrupted power supply with a reduced cost. For example, Patent Document 1 teaches a power supply system securing power sharing between devices via a short-circuit check network preventing a short-circuit event occurring on one device due to a power failure occurring on another device.

Patent Document 2 teaches a power supply system for supplying power to each device via a plurality of power supply units, wherein upon detection of a failure on one power supply unit, the other power supply unit is rectified to form a power supply line supplying redundant power to the device.

Patent Document 3 teaches a power management system adapted to a blade server, which controls a blade to reduce its power consumption exceeding supplied power.

Patent Document 4 teaches a power supply system using fuel cells subjected to inspection as to whether or not they are each capable of generating a prescribed amount of power regardless of degradation, wherein each fuel cell is inspected in terms of a maximum power supply capacity so as to acquire the information regarding a redundant power supply capacity, based on which a normal fuel cell maintaining the redundant power supply capacity is used but a degraded fuel cell having no redundant power supply capacity is avoided.

Patent Document 5 teaches a redundant power supply system for diminishing the circumstances in which adequate power is not temporarily obtained due to the erroneous detection of a power supply failure or due to the occurrence of a power supply failure.

In the power supply system of FIG. 6 in which power supply is controlled in units of cell boxes, it is necessary for each cell box to normally turn on three power supply units securing an N+1 redundancy of power supply. It is necessary for the platform including four cell boxes each equipped with three power supply units to normally turn on the total of twelve power supply units securing an N+1 redundancy of power supply. The present inventor has recognized that, when two or more power supply units fail in a specific cell box which thus becomes inoperable and which becomes isolated from other cell boxes, the platform likely suffers from a resource shortage in the operating system.

Patent Document 1 employs the short-circuit check network for preventing a short-circuit event occurring on one device due to a power failure occurring on another device, thus achieving power sharing between plural devices. However, it does not demonstrate an external power supply that provides power to plural cell boxes via independent power supply lines without the intervention of the short-circuit check network.

Patent Document 2 demonstrates a redundant power supply by newly forming a power supply line via plural devices upon detection of a failure on one power supply unit. However, it does not demonstrate a redundant power supply in light of the number of power supply units being turned off in each device, and the information regarding power supply units mounted on each device other than the information regarding a failure occurring on each power supply unit, and it does not demonstrate that a redundant power supply is secured using a fixed power supply line without using another power supply line newly formed upon detection of a failure on one power supply unit.

Patent Document 3 demonstrating a power consumption control is not applicable to the platform that maintains a redundant power supply based on the power consumption without controlling the power consumption.

Patent Document 4 demonstrates a redundant power supply capacity in light of a maximum power supply capacity in each fuel cell, but it does not demonstrate that power supply units other than fuel cells operate based on an external power supply for converting an AC power of 100V or 200V into a DC power. Herein, a redundant power supply capacity is estimated by subtracting a power consumption of each cell box from the total power generated by power supply units being turned on in each cell box in the platform.

Patent Document 5 demonstrates the diminished circumstances in which adequate power is not temporarily obtained due to the erroneous detection of a power supply failure or due to the occurrence of a power supply failure, but it does not demonstrate that the total power generated by power supply units installed in cell boxes is shared and distributed between cell boxes.

### SUMMARY

The invention seeks to solve the above problem or to improve upon the problem at least in part.

In one embodiment, there is provided a power supply system in which the total power supply is shared between cell boxes in the platform so as to achieve redundant power supply.

In another embodiment, there is provided a power supply method implementing power sharing between cell boxes in a single platform so as to achieve redundant power supply.

The platform is constituted of a plurality of processing devices (e.g. cell boxes) for processing basic information units, each of which is equipped with a plurality of power supply units (PSU). In addition, the processing device includes a secondary power supply unit capable of generating the power of at least one power supply unit in connection with the power supply units, so that a plurality of secondary power supply units included in the processing devices is interconnected together via a power cable. Furthermore, the processing device includes a controller (e.g. a baseboard management controller, BMC), so that a plurality of controllers included in the processing devices cooperate with each other via a local area network (LAN).

The controller calculates the maximum power consumption of the processing device based on its configuration. In addition, the controller calculates an adequate number of power supply units being turned on to meet the maximum power consumption. Furthermore, the controller calculates the redundant power supply corresponding to the power of one power supply unit times the adequate number minus the maximum power consumption.

When one processing device suffers from a power shortage below the power of one power supply unit so that the redundant power supply thereof is below zero, the other processing device additionally turns on the power supply unit being presently turned off or the secondary power supply unit being presently turned off. Thus, it is possible to recover the redundant power supply being shared between the processing devices via the secondary power supply units.

As described above, the present invention demonstrates the following effects and advantages.
(1) Since the adequate number of power supply units are selectively turned on to meet the maximum power consumption of the processing device, it is possible to reduce the total power consumption of the platform, thus achieving energy saving.
(2) It is possible to achieve the N+1 redundancy of power supply with the platform in such a way that the total redundant power supply is normally maintained over the power of one power supply unit irrespective of a failure occurring on the processing device. In a failure event in which one power supply unit fails in the processing device, it is possible to easily recover the power shortage by sharing the redundant power supply between the processing devices via the secondary power supply units.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram showing the constitution of a power supply system adapted to a platform including a plurality of cell boxes according to a preferred embodiment of the present invention;

FIG. 2 is a block diagram showing the constitution of the cell box including a baseboard management controller, a plurality of power supply units, and a secondary power supply unit;

FIG. 3 is a block diagram showing the constitution of the platform in which each cell box includes the baseboard management controller for performing a platform control process and a cell control process;

FIG. 4 is a flowchart showing procedures implemented by the cell control process managing power supply to each cell box;

FIG. 5 is a flowchart showing procedures implemented by the platform control process managing a redundant power supply; and

FIG. 6 is a block diagram showing a typical example of a power supply system including a plurality of cell boxes each equipped with a plurality of power supply units securing a redundant power supply.

### DETAILED DESCRIPTION OF PREFERRED EMBODIMENTS

The present invention will be now described herein with reference to illustrative embodiments. Those skilled in the art will recognize that many alternative embodiments can be accomplished using the teachings of the present invention and that the invention is not limited to the embodiments illustrated for explanatory purposes.

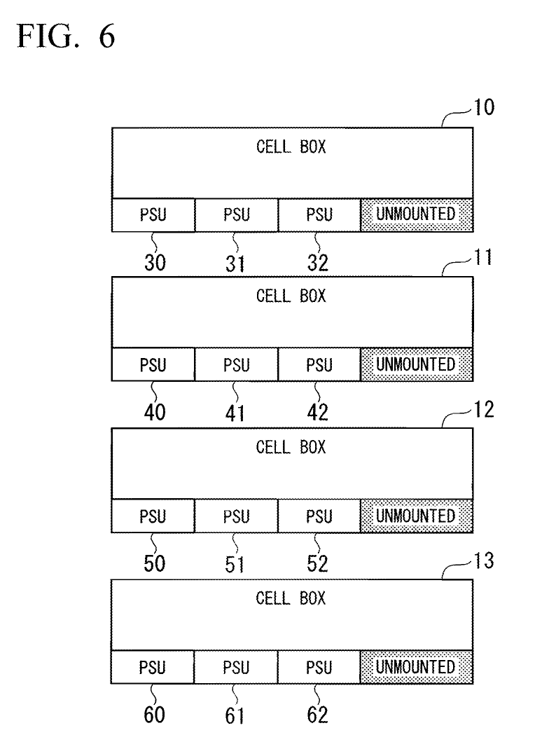

The constitution of a power supply system of the present invention is similar to that of the power supply system shown in FIG. 6, which is constituted of the four cell boxes 10-13 equipped with power supply units (PSU) 30-32, 40-42, 50-52, and 60-62. The present invention is characterized in that a secondary power supply unit (or a secondary PSU) is mounted on an unoccupied slot of each cell box already mounting three power supply units (PSU), so that all the secondary power supply units mounted on cell boxes are interconnected together so as to create redundant power (i.e. unused power or remaining power corresponding to supplied power minus consumed power), which is shared between the cell boxes.

In addition, baseboard management controllers (BMC) are mounted on cell boxes so as to perform DC power control on power supply units (PSU), thus optimally controlling redundant power supply adapted to the constitution and status of the platform via secondary power supply units.

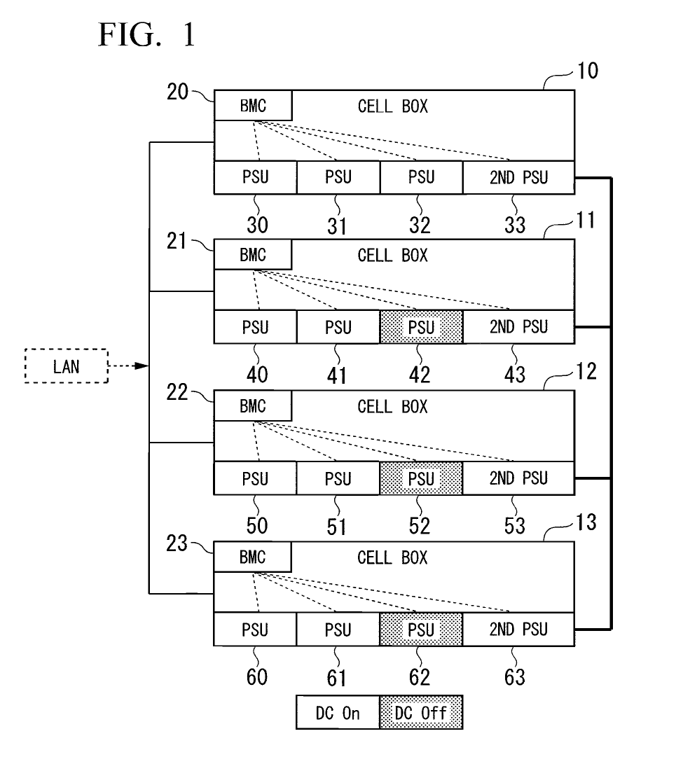

FIG. 1 is a block diagram showing the constitution of the power supply system according to a preferred embodiment of the present invention, wherein the cell box 10 including three power supply units 30-32 is equipped with a baseboard management controller 20 and a secondary power supply unit 33; the cell box 11 including three power supply units 40-42 is equipped with a baseboard management controller 21 and a secondary power supply unit 43; the cell box 12 including three power supply units 50-52 is equipped with a baseboard management controller 22 and a secondary power supply unit 53; and the cell box 13 including three power supply units 60-62 is equipped with a baseboard management controller 23 and a secondary power supply unit 63. The baseboard management controllers (BMC) 20-23 perform various operations such as ON/OFF controls and startup controls on the cell boxes 10-12.

The secondary power supply unit 33 is connected to a power supply line constituted of the power supply units 30-32 in the cell box 10; the secondary power supply unit 43 is connected to a power supply line constituted of the power supply units 40-43 in the cell box 11; the secondary power supply unit 53 is connected to a power supply line constituted of the power supply units 50-52 in the cell box 12; and the secondary power supply unit 63 is connected to a power supply line constituted of the power supply units 60-63 in the cell box 13. The secondary power supply units 33, 43, 53, and 63 are connected together via a power cable, thus supplying redundant power to the cell boxes 10-13.

The baseboard management controllers 20-23 include respective registers (not shown) to control the power supply units 30-33, 40-43, 50-53, and 60-63 in the cell boxes 10-13, thus securing access to the power supply units by way of a prescribed interface such as “I2C” (i.e. Inter-Integrated Circuit, two-wired serial communication).

The present embodiment illustrates the four cell boxes 10-13; but this is not a restriction. The present embodiment is applicable to an arbitrary number of cell boxes.

The present embodiment illustrates three power supply units per each cell box; but this is not a restriction. The present embodiment is applicable to an arbitrary multiple number of power supply units per each cell box.

The present embodiment illustrates a secondary power supply unit mounted on an unoccupied slot of each cell box; but this is not a restriction. The present embodiment is applicable to another type of cell box arbitrarily locating a secondary power supply unit in a prescribed area.

Each baseboard management controller (BMC) is capable of accessing hardware components such as a CPU, a memory, and an I/O unit mounted on each cell box by way of the I2C interface or the like. The baseboard management controller calculates the maximum consumption of power consumed by hardware components. Next, the baseboard management controller turns on an adequate number of power supply units that are necessary to meet the maximum power consumption based on the mounting information of power supply units. When the maximum power consumption falls within the sum of powers generated by two power supply units, the baseboard management controller turns on two power supply units.

In addition, the baseboard management controller, which is installed in a cell box of a platform, implements a cell control process for managing power supply to the cell box by power supply units based on the maximum power consumption, and a platform control process for managing power supply to the platform.

The cell control process creates ternary information representing the redundant power (corresponding to the sum of powers generated by power supply units, which are turned on, minus the maximum power consumption), the number of power supply units which are turned off, and the confirmation as to whether or not the secondary power supply unit is mounted on each cell box. The cell control process forwards the ternary information to the platform control process.

The platform control process gathers the ternary information from all cell boxes. Upon confirmation that the total redundant power derived from all cell boxes is above zero (in other words, no power shortage occurs) and that all cell boxes are equipped with secondary power supply units respectively, the platform control process subsequently confirms whether or not the total redundant power is above the power generated by one power supply unit.

When the total redundant power is less than the power generated by one power supply unit, the platform control process selects one of cell boxes which reports that at least one power supply unit is turned off, and then instructs the cell control process of the selected cell box to turn on the power supply unit.

As described above, when the total redundant power remaining in the platform is above the power of one power supply unit, it is possible to share the total redundant power between the cell boxes. Thus, it is possible to supply the redundant power to the “power-shorted” cell box when necessary.

Next, a failure recovery process handling a failure occurring on any one of power supply units will be described below.

When a failure occurs on one power supply unit within power supply units installed in each cell box, the cell control process of the baseboard management controller controlling the “failed” power supply unit notifies the platform control process of failure information.

Upon reception of the failure information, the platform control process requests all cell control processes to retransmit the ternary information representing the redundant power, the number of power supply units which are turned off, and the confirmation as to whether or not the secondary power supply unit is mounted on each cell box.

That is, the baseboard management controller of each cell box performs the cell control process so as to recalculate the maximum power consumption and the total power supply, thus updating redundant power supply. Then, the cell control process provides the platform control process with the “updated” ternary information representing the “updated” redundant power supply, the number of power supply units which are turned off, and the confirmation as to whether or not the secondary power supply unit is mounted on each cell box.

Collecting the ternary information from all cell control processes, the platform control process selects one of cell boxes so as to designate one power supply unit included in the selected cell box, which is substituted for the failed power supply unit. The platform control process instructs the cell control process of the selected cell box to turn on the designated power supply unit.

When one power supply unit fails in each cell box, it is possible to rapidly recover desired power supply environments with an N+1 redundancy of power supply in a short period of time (where “N” denotes an adequate number of power supply units matching the maximum power consumption). It is possible to achieve power saving by selectively turning on an adequate number of power supply units. The power supply unit of the present embodiment is designed based on the premise that the secondary power supply unit mounted on each cell box is capable of generating the power of one power supply unit. It is possible to increase the power generation capacity of the secondary power supply unit to be greater than the power of one power supply unit or to be greater than the maximum power consumption of each cell box, wherein it is possible to compensate for the maximum power consumption of one cell box in which all power supply units fail by use of the total redundant power remaining in other cell boxes. Thus, it is possible to achieve the uninterrupted operation of the information processing platform irrespective of failures occurring on power supply units of cell boxes.

The conventional power supply system requires that, when the total power generated by two power supply units meets the maximum power consumption of each cell box within four cell boxes included in the information processing platform shown in FIG. 6, an N+1 redundancy of power supply is secured by normally turning on three power supply units in each cell box. In contrast, the present embodiment additionally introduces one secondary power supply unit in addition to three power supply units in each cell box, wherein four secondary power supply units in total are interconnected together via a power cable so as to provide additional redundant power shared between cell boxes.

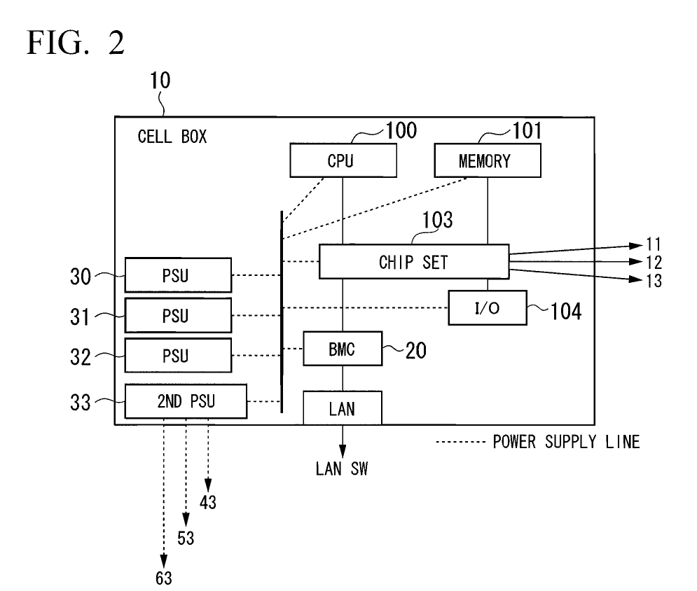

FIG. 2 is a block diagram showing the constitution of the cell box 10 in the power supply system of the present embodiment. The constitution shown in FIG. 2 is applied to other cell boxes 11-13.

The cell box 10 includes a CPU 100, a memory 101, a chip set 103, and an I/O unit 104 as well as the baseboard management controller 20, the power supply units 30-32, and the secondary power supply unit 33.

The cell box 10 of FIG. 2 is connected to the other cell boxes 11-13 via the chip set 103, thus constituting a single platform including a plurality of cell boxes 10-13. The baseboard management controller 20 performs DC power control, booting control, and failure detection in cooperation with the CPU 100, the memory 101, and the chip set 103. The baseboard management controller 20 is accessible to the power supply units 30-33 via the I2C interface, thus managing and controlling power which is generated by the power supply units 30-33 and supplied to other constituent elements in the cell box 10. The secondary power supply unit 33 is interconnected to the secondary power supply units 43, 53, and 63 included in the cell boxes 11, 12, and 13. In this connection, the cell boxes 10-13 are connected together with a local area network (LAN) via LAN switches (not shown).

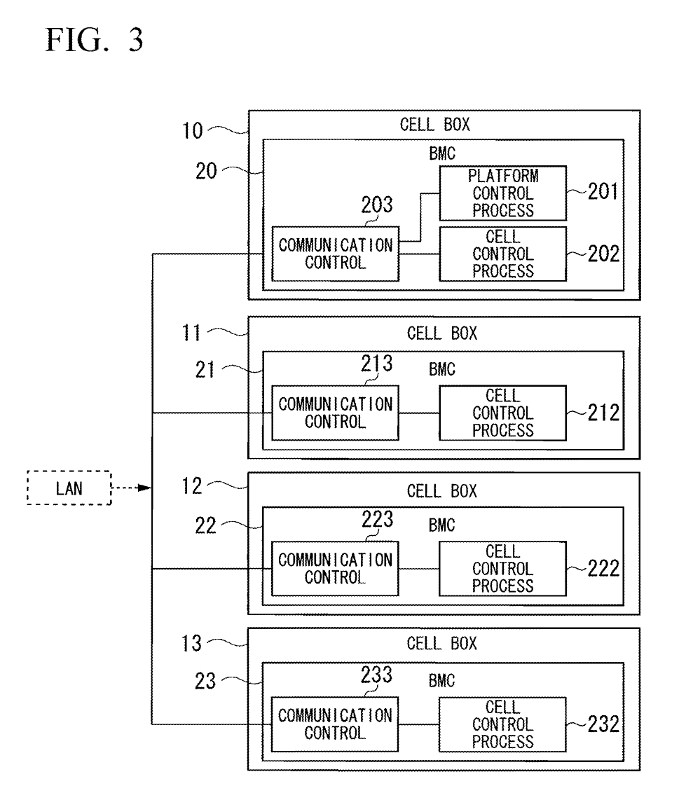

FIG. 3 is a block diagram showing the constitution of a single platform including the cell boxes 10-13 and employing the power supply system of the present invention.

Specifically, the baseboard management controller 20 of the cell box 10 includes a platform control process 201, a cell control process 202, and a communication control unit 203; the baseboard management controller 21 of the cell box 11 includes a cell control process 212 and a communication control unit 213; the baseboard management controller 22 of the cell box 12 includes a cell control process 222 and a communication control unit 223; and the baseboard management controller 23 of the cell box 13 includes a cell control process 232 and a communication control unit 233. The platform control process 201 manages power supply to the platform, while the cell control processes 202, 212, 222, and 232 manage power supply to the cell boxes 10, 11, 12, and 13 respectively. During execution of the platform control process 201 and during execution of the cell control processes 202, 212, 222, and 232, the communication control units 203, 213, 223, and 233 are performing mutual communications therebetween via a local area network (LAN).

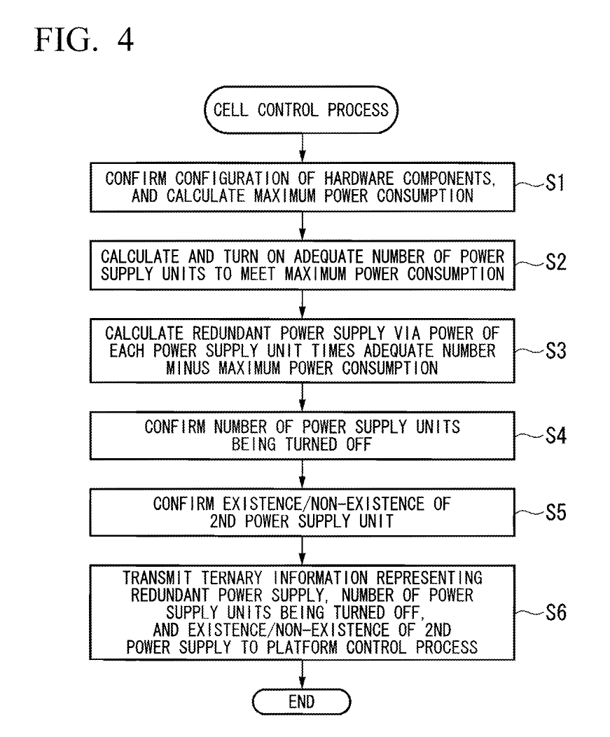

FIG. 4 is a flowchart showing procedures implemented by each cell control process managing power supply to each cell box, which will be described in conjunction with FIGS. 1 to 3.

The baseboard management controller initiates the cell control process upon turning on an AC power (not shown) with each cell box or upon reception of a retransmission request regarding the foregoing information by the platform control process 201.

(Step 1)

The baseboard management controller confirms the configuration of hardware components (e.g., the CPU, memory, I/O, and chip set) included in the cell box and then calculates the maximum power consumption.

(Step 2)

The baseboard management controller calculates an adequate number of power supply units which should be turned on to meet the maximum power consumption with reference to the amount of power generated by a single power supply unit, so that the adequate number of power supply units is collectively turned on. Specifically, the baseboard management controller confirms ON/OFF statuses on all power supply units (which are assigned with serial numbers in advance) included in the cell box so as to count the number of power supply units being presently turned on, thus determining an additional number of power supply unit(s) which should be additionally turned on. Herein, the ON/OFF status confirmation is performed in the order of serial numbers starting from the smallest serial number as to whether each power supply unit is turned on or off, so that the power supply unit having a smaller serial number which is presently turned off is controlled to be turned on.

(Step S3)

The baseboard management controller multiplies the power of a single power supply unit by the total number of power supply units being turned on, thus calculating power supply. Then, it subtracts the maximum power consumption from the calculated power supply so as to calculate redundant power supply.

(Step S4)

The baseboard management controller performs the ON/OFF status confirmation on all power supply units included in the cell box so as to confirm the number of power supply units being presently turned off.

(Step S5)

The baseboard management controller confirms whether or not the cell box is equipped with the secondary power supply unit, thus producing the information regarding the confirmation result of the secondary power supply unit.

(Step S6)

The baseboard management controller gathers the redundant power supply (which is calculated in step S3), the number of power supply units being turned of (which is confirmed in step S4), and the information of the confirmation result of the secondary power supply unit (which is produced in step S5) so as to constitute the ternary information, which is then transmitted to the platform control process 201. After completion of steps S1 to S6, the baseboard management controller terminates the cell control process.

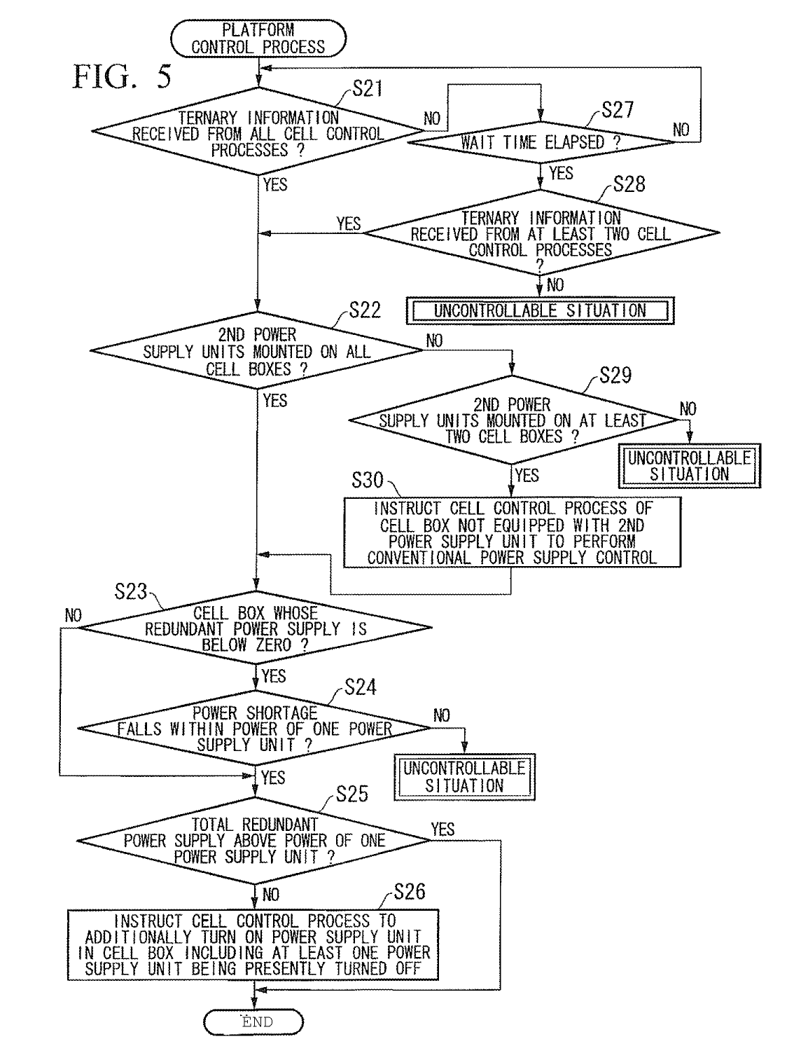

FIG. 5 is a flowchart showing procedures implemented by the platform control process 201 managing redundant power supply, which will be described in conjunction with FIGS. 1 to 3.

The platform control process 201 gathers the ternary information transmitted thereto from all the cell control processes 202, 212, 222, and 232, thus calculating total redundant power supply per a single platform. When the total redundant power supply is smaller than the power of a single power supply unit, it is necessary to increase the total redundant power supply over the power of a single power supply unit; hence, the platform control process 201 selects one of the cell boxes 10-13 so as to designate a prescribed power supply unit which is presently turned off but which should be turned on in the selected cell box. The baseboard management controller 20 initiates the platform control process 201 upon turning on an AC power on the cell box 10 or upon reception of the failure information representing a failure occurring on a certain power supply unit from one of the cell control processes 202, 212, 222, and 232.

(Step S21)

The baseboard management controller 20 verifies whether or not it completely receives the ternary information from all the cell control processes 202, 212, 222, and 232. When the decision result of step S21 is “YES”, the flow proceeds to step S22. When the baseboard management controller 20 fails to receive the ternary information from any one of the cell control processes 202, 212, 222, and 232 so that the decision result of step S21 is “NO”, the flow proceeds to step S27.

(Step S22)

The baseboard management controller 20 verifies whether or not the secondary power supply units 33, 43, 53, and 63 are respectively mounted on the cell boxes 10, 11, 12, and 13. When the decision result of step S22 is “YES”, the flow proceeds to step S23. When any one of the secondary power supply units 33, 43, 53, and 63 is not mounted on the corresponding one of the cell boxes 10, 11, 12, and 13 so that the decision result of step S22 is “NO”, the flow proceeds to step S29.

(Step S23)

The baseboard management controller 20 verifies whether or not the redundant power supply is below zero with respect to the cell boxes 10-13, i.e. whether or not any one of the cell boxes suffers from a power shortage. When all the cell boxes 10-13 demonstrate the redundant power supply above zero so that the decision result of step S23 is “NO”, the flow proceeds to step S25. When any one of the cell boxes 10-13 demonstrate the redundant power supply below zero, the flow proceeds to step S24.

(Step S24)

The baseboard management controller 20 verifies whether or not the power shortage falls within the power of a single power supply unit. When the decision result of step S24 is “YES”, the flow proceeds to step S25. When the power shortage is above the power of a single power supply unit or beyond the power supply capacity of the secondary power supply unit, the decision result of step S24 turns to “NO” indicating an uncontrollable situation of the power supply system, so that the platform control process 201 terminates the processing thereof.

(Step S25)

The baseboard management controller 201 verifies whether or not the total redundant power supply reported from all the cell control processes 202, 212, 222, and 232 is above the power of a single power supply unit. When the decision result of step S25 is “YES”, the platform control process 201 terminates the processing thereof because the present situation indicates that the platform already achieves an N+1 redundancy of power supply. When the total of redundant power supplies is below the power of a single power supply unit so that the decision result of step S25 is “NO”, the flow proceeds to step S26.

(Step S26)

The baseboard management controller 20 faces the situation in which the platform does not presently demonstrate the N+1 redundancy of power supply due to the temporary occurrence of the power shortage, wherein the baseboard management controller 20 instructs a certain cell control process of the cell box including at least one power supply unit being presently turned off to additionally turn on the power supply unit, thus controlling the total redundant power supply over the power of a single power supply unit. This implements the N+1 redundancy of power supply. After completion of step S26, the platform control process 201 terminates the processing thereof.

(Step S27)

The flow reverts to step S21 so as to watch whether or not the platform control process 201 completely receives the ternary information from all the cell control processes 202, 212, 222, and 232 for a prescribed wait time. Upon a lapse of the prescribed wait time, the flow proceeds to step S28.

(Step S28)

The baseboard management controller 20 verifies whether or not it receives the ternary information from at least two cell control processes. When the decision result of step S28 is “YES”, the flow proceeds to step S22 in which the platform control process 201 performs the processing in cooperation with at least two cell control processes. When the baseboard management controller 20 receives the ternary information from only one cell control process or when it does not receive the ternary information at all, the platform control process 201 faces the uncontrollable situation; hence, the processing of FIG. 5 is terminated.

(Step S29)

The baseboard management controller 20 verifies whether or not secondary power supply units are mounted on at least two cell boxes. When the decision result of step S29 is “YES”, the flow proceeds to step S30 so as to achieve the N+1 redundancy of power supply in cooperation with at least two cell boxes equipped with secondary power supply units. When the secondary power supply unit is mounted on only one cell box or when none of the cell boxes 10-13 is equipped with the secondary power supply unit, the platform control process 201 faces the uncontrollable situation; hence, the processing of FIG. 5 is terminated.

(Step S30)

The baseboard management controller 20 instructs at least one cell control process of the cell boxes not equipped with the secondary power supply unit to perform the conventional power supply control. Then, the flow proceeds to step S23.

The power supply system of the present embodiment is implemented by mounting secondary power supply units (which are connected to power supply lines and are mutually connected together via a power cable) on at least two cell boxes, wherein it is possible to share the redundant power supply (corresponding to the power supply minus power consumption, which is not used in each cell box) between cell boxes.

Since the baseboard management controller (BCM) performs DC power control on power supply units, it is possible to optimally control the redundant power supply suiting the configuration of the platform via secondary power supply units.

As described above, the present embodiment is designed to supply redundant power to the platform via the secondary power supply unit with the N+1 redundancy of power supply, wherein the secondary power supply unit is limited in capacity to additionally supply only the power of one power supply unit to the other cell box. In other words, the present embodiment is not designed to cope with a relatively high power shortage over the power of one power supply unit.

It is possible to modify the present embodiment such that the capacity of the secondary power supply unit is increased to provide a higher power corresponding to the sum of power of two or more power supply units. This copes with a serious failure event, in which all the power supply units fail in the cell box, as long as the maximum power consumption of the cell box falls within the power of the secondary power supply unit, wherein the secondary power supply unit is capable of compensating for “failed” power supply units and uninterruptedly supplying an adequate amount of power to the other cell box, thus securing uninterrupted operation of the platform.

At least of constituent elements of the power supply unit of the present embodiment can be implemented by way of computer-controlled procedures, wherein programs representing the aforementioned procedures shown in FIGS. 4 and 5 are stored in any types of computer-readable digital storage media such as a semiconductor memory, CD-ROM, and magnetic tapes, which are generally available. That is, any types of computing machines such as microcomputers, personal computers, and general-purpose computers are implemented to run programs by reading them from digital storage media.

Lastly, it is apparent that the present invention is not limited to the present embodiment, but may be modified and changed without departing from the scope and spirit of the invention.

What is claimed is:

1. A power supply system adapted to a platform including a plurality of processing devices for processing basic information units, each of which is equipped with a plurality of power supply units, comprising:
a plurality of secondary power supply units which are installed in the plurality of processing devices in connection with the plurality of power supply units and which are interconnected together via a power cable, wherein each secondary power supply unit is capable of generating power of at least one power supply unit; and
a plurality of controllers which are installed in the plurality of processing devices,
wherein each controller determines whether to turn on the secondary power supply unit to meet a maximum power consumption of each processing device, and
wherein when a redundant power supply of one processing device is lower than power of one power supply unit, the controller controls another processing device so as to turn on its secondary power supply unit.

2. The power supply system according to claim 1, wherein upon reception of a transmission request of information regarding the processing device, the controller of the processing device confirms a configuration of the processing device so as to calculate the maximum power consumption; the controller calculates an adequate number of power supply units being turned on to meet the maximum power consumption; and the controller calculates the redundant power supply corresponding to the power of one supply unit times the adequate number minus the maximum power consumption.

3. The power supply system according to claim 2, wherein the configuration of the processing device represents a plurality of hardware components, based on which the controller calculates the maximum power consumption.

4. The power supply system according to claim 1, wherein at least two processing devices are equipped with the secondary power supply units which are interconnected together via the power cable, wherein when one processing device suffers from a power shortage below the power of one power supply unit so that the redundant power supply thereof is below zero, the controller of the other processing device additionally turns on the power supply unit being presently turned off or the secondary power supply unit being presently turned off.

5. The power supply system according to claim 1, wherein the secondary power supply unit is mounted on an unoccupied slot of the processing device in connection with the plurality of power supply units.

6. A power supply method adapted to a platform including a plurality of processing devices for processing basic information units, each of which is equipped with a plurality of power supply units and at least one secondary power supply unit capable of generating power of one power supply unit and interconnected with a power cable, comprising:
calculating a maximum power consumption of the processing device based on its configuration;
calculating an adequate number of power supply units being turned on to meet the maximum power consumption; and
calculating a redundant power supply corresponding to the power of one power supply unit times the adequate number minus the maximum power consumption, thus sharing the redundant power supply between the plurality of processing devices.

7. The power supply method according to claim 6, wherein when one processing device suffers from a power shortage below the power of one power supply unit so that the redundant power supply thereof is below zero, the other processing device additionally turns on the power supply unit being presently turned off or the secondary power supply unit being presently turned off, thus recovering the redundant power supply via the secondary power supply unit.
